(19) United States
(12) Patent Application Publication
(10) Pub. No.: US 2021/0332596 A1
(43) Pub. Date: Oct. 28, 2021

(54) Non-Decorative Industrial Grade Self-Adhesive Tile and Method of Manufacturing Thereof

(71) Applicant: Grain Elevator Repair Products, LLC, Austin, TX (US)

(72) Inventor: Ryan Michael Jones, Colbert, WA (US)

(73) Assignee: Grain Elevator Repair Products, LLC, Austin, TX (US)

(21) Appl. No.: 16/605,336

(22) PCT Filed: Jun. 21, 2019
(86) PCT No.: PCT/US2019/038360

§ 371 Date: Oct. 15, 2019

Related U.S. Application Data
(60) Provisional application No. 62/816,072, filed on Mar. 9, 2019.
(60) Provisional application No. 62/790,717, filed on Jan. 10, 2019.
(60) Provisional application No. 62/690,028, filed on Jun. 26, 2018.

(51) Int. Cl. E04F 13/14; B32B 7/06; B32B 5/18; B32B 7/12; B32B 18/00; B32B 37/10; E04F 13/08

(52) U.S. Cl. CPC E04F 13/142; B32B 7/06; B32B 5/18; B32B 7/12; B32B 2266/0242; B32B 37/10; E04F 13/0885; B32B 2419/04; B32B 18/00

(57) ABSTRACT

A non-decorative industrial grade self-adhesive tile comprised of an abrasion-resistant alumina ceramic tile, a silane coupling agent and double-sided (double-coated) acrylic foam super high bonding tape with release liner. The abrasion-resistant alumina ceramic tile may be comprised of aluminum oxide, crystalline silica (amorphous) and magnesium oxide. The silane coupling agent may be comprised of materials selected from the group of isopropyl alcohol, water and glycidoxypropyltrimethoxysilane. The double-sided (double-coated) acrylic foam super high bonding tape is comprised a foam carrier and an acrylic adhesive.

### CROSS-REFERENCE TO RELATED APPLICATIONS

The present application claims the benefit of the filing date of U.S. Provisional Patent application Ser. No. 62/816,072 filed by the present inventor on Mar. 9, 2019, U.S. Provisional Patent Application Ser. No. 62/790,717 filed by the present inventor on Jan. 10, 2019, and U.S. Provisional Patent Application Ser. No. 62/690,028 filed by the present inventor on Jun. 26, 2018.

The aforementioned provisional patent application is hereby incorporated by reference in its entirety.

### STATEMENT REGARDING FEDERALLY SPONSORED RESEARCH OR DEVELOPMENT

None.

### BACKGROUND OF THE INVENTION

### Field Of The Invention

The present invention relates to the manufacture of self-adhesive, abrasion-resistant, non-decorative tile, brick or plate for bulk materials handling or military applications.

### Brief Description Of The Related Art

Non-decorative industrial grade tile has been in use for many years but has suffered from a variety of drawbacks. A significant drawback of the conventional non-decorative industrial ceramic tile is the large amount of time needed for installation of the tiles. Another drawback is the corrosive behavior of traditional installation methods such as acid based silicone caulk and other corrosive and hazardous adhesives. Further, the cure time for traditional methods such as silicone caulk, Epoxy, (Bisphenol A) BPA, and other traditional adhesives can take up to 48 hours or more until the tiles are operational. Still further, there are health and safety risks and an environmental risk to the Food Chain/BioSphere due to the traditional silicone caulk and Epoxy and (Bisphenol-A) BPA adhesives and other traditional adhesives. Additionally, conventional industrial grade tiles have significant drawback in their lack of uniform installation quality with traditional installation methods such as silicone caulk, Epoxy, (Bisphenol-A) BPA adhesives and other traditional adhesives when manually applied can never maintain a consistent adhesive level and thickness which inevitably reduces the tile bonding lifespan in an abrasive and high-impact industrial environment.

### SUMMARY OF THE INVENTION

In a preferred embodiment, the present invention is non-decorative industrial grade abrasion-resistant self-adhesive tile, brick or plate. The tile is comprised of an abrasion-resistant material such as alumina ceramic, silicon carbide or boron nitride tile, a silane coupling agent and double-sided (double-coated) acrylic foam super high bonding tape with release liner. The abrasion-resistant tile, for example, may be comprised of materials selected from the group of aluminum oxide, crystalline silica (amorphous) and magnesium oxide. The aluminum oxide may form 85%-100% by weight of the abrasion-resistant alumina ceramic tile. The crystalline silica may form 0.1%-1% by weight of the abrasion-resistant alumina ceramic tile. The magnesium oxide may form 0.1%-1% by weight of the abrasion-resistant alumina ceramic tile. The silane coupling agent may be comprised of materials selected from the group of isopropyl alcohol, water and glycidoxypropyltrimethoxysilane. The isopropyl alcohol forms 90%-92% by weight of the silane coupling agent. Water forms 8%-9% by weight of the silane coupling agent. The glycidoxypropyltrimethoxysilane may form greater than 0% but less than 1% by weight of the silane coupling agent. The double-sided (double-coated) acrylic foam super high bonding tape may comprise a foam carrier and an acrylic adhesive release liner.

In another embodiment, the present invention is a method for manufacturing a non-decorative industrial grade self-adhesive abrasion-resistant tile. The method comprises the steps of applying a silane coupling agent to one complete side of an abrasion-resistant alumina ceramic tile, gently scrubbing the covered side of abrasion-resistant alumina ceramic tile with a non-fibrous sponge or cloth until all of the silane coupling agent is removed, air drying the abrasion-resistant alumina ceramic tile in a low humidity environment, applying a silane coupling agent to one complete side of the abrasion-resistant alumina ceramic tile a second time, letting the abrasion-resistant alumina ceramic tile dry in a low humidity environment, applying a double-sided (double-coated) acrylic foam super high bonding tape with release liner to the combination of abrasion-resistant alumina ceramic tile and silane coupling agent by removing a release liner from one side of the double-sided (double-coated) acrylic foam super high bonding tape with release liner and then rolling the double-sided (double-coated) acrylic foam super high bonding tape with release liner onto the silane coupling agent on the abrasion-resistant alumina ceramic tile, using a weighted roller press with pressure exceeding 20 PSI from one edge to another on double-sided (double-coated) acrylic foam super high bonding tape with release liner stimulating a pressure sensitive adhesive and pushing out any remaining air, and/or using a flat/smooth metal plate apply at least 20 PSI of uniform platen pressure to double-sided (double-coated) acrylic foam super high bonding tape with release liner.

In other embodiments, rather than alumina, the tile may be, for example, silicon carbide, boron nitride, silicon nitride, tungsten carbide, zirconia, carbon fiber/aluminum composites, aluminum nitride, titanium diboride, yttrium oxide, titanate, or porcelain.

Still other aspects, features, and advantages of the present invention are readily apparent from the following detailed description, which simply illustrates preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1A is a drawing of a non-decorative abrasion-resistant industrial grade self-adhesive tile or other building material in accordance with a preferred embodiment of the present invention.

FIG. 1B is a drawing of an alternate embodiment of a non-decorative abrasion-resistant industrial grade self-adhesive tile or other building material having a metal backing in accordance with another preferred embodiment of the present invention.

FIG. 2A is a flow chart of method for manufacturing a non-decorative abrasion-resistant industrial grade self-adhesive tile, brick or plate in accordance with a preferred embodiment of the present invention.

FIG. 2B is a flow chart of an alternate method for preparing and installing a non-decorative abrasion-resistant industrial grade self-adhesive tile, brick or plate in accordance with a preferred embodiment of the present invention.

FIG. 3A is a rear perspective view of a first embodiment of a non-decorative abrasion-resistant industrial grade tile in accordance with the present invention;

FIG. 3B is a front view of the first embodiment of a non-decorative abrasion-resistant industrial grade tile in accordance with the present invention;

FIG. 3C is a rear view of the first embodiment of a non-decorative abrasion-resistant industrial grade tile in accordance with the present invention;

FIG. 3D is a bottom view of the first embodiment of a non-decorative abrasion-resistant industrial grade tile in accordance with the present invention;

FIG. 3E is a top view of the first embodiment of a non-decorative abrasion-resistant industrial grade tile in accordance with the present invention;

FIG. 3F is a left view of the first embodiment of a non-decorative abrasion-resistant industrial grade tile in accordance with the present invention; and

FIG. 3G is a right view of the first embodiment of a non-decorative abrasion-resistant industrial grade tile in accordance with the present invention.

FIG. 4 is a cross-sectional view of a non-decorative abrasion-resistant industrial hex tile in accordance with a second preferred embodiment of the present invention.

FIG. 5A is a front perspective view of the non-decorative abrasion-resistant industrial hex tile in accordance with the second preferred embodiment of the present invention;

FIG. 5B is a front view of the non-decorative abrasion-resistant industrial hex tile in accordance with the second preferred embodiment of the present invention;

FIG. 5C is a rear view of the non-decorative abrasion-resistant industrial hex tile in accordance with the second preferred embodiment of the present invention;

FIG. 5D is a bottom view of the non-decorative abrasion-resistant industrial hex tile in accordance with the second preferred embodiment of the present invention;

FIG. 5E is a top view of the non-decorative abrasion-resistant industrial hex tile in accordance with the second preferred embodiment of the present invention;

FIG. 5F is a left view of the non-decorative abrasion-resistant industrial hex tile in accordance with the second preferred embodiment of the present invention;

FIG. 5G is a right view of the non-decorative abrasion-resistant industrial hex tile in accordance with the second preferred embodiment of the present invention; and

FIG. 5H is a rear perspective view of the non-decorative abrasion-resistant industrial hex tile in accordance with the second preferred embodiment of the present invention with the release liner partially peeled back.

FIG. 6A is a front perspective view of a cuttable non-decorative, abrasion-resistant, industrial grade self-adhesive tile in accordance with the second preferred embodiment of the present invention.

FIG. 6B is a front view of the cuttable non-decorative, abrasion-resistant, industrial grade self-adhesive tile in accordance with the second preferred embodiment of the present invention;

FIG. 6C is a rear view of the cuttable non-decorative, abrasion-resistant, industrial grade self-adhesive tile in accordance with the second preferred embodiment of the present invention;

FIG. 6D is a bottom view of the cuttable non-decorative, abrasion-resistant, industrial grade self-adhesive tile in accordance with the second preferred embodiment of the present invention;

FIG. 6E is a top view of the cuttable non-decorative, abrasion-resistant, industrial grade self-adhesive tile in accordance with the second preferred embodiment of the present invention;

FIG. 6F is a left view of the cuttable non-decorative, abrasion-resistant, industrial grade self-adhesive tile in accordance with the second preferred embodiment of the present invention;

FIG. 6G is a right view of the cuttable non-decorative, abrasion-resistant, industrial grade self-adhesive tile in accordance with the second preferred embodiment of the present invention; and

FIG. 6H is a perspective view of the cuttable non-decorative, abrasion-resistant, industrial grade self-adhesive tile in accordance with the second preferred embodiment of the present invention with the release liner partially peeled back.

FIG. 7 is a front perspective view of the cuttable non-decorative, abrasion-resistant, industrial grade self-adhesive tile of FIGS. 6A-6H in accordance with the second preferred embodiment of the present invention.

FIGS. 8A-8E illustrate a method for cutting the cuttable non-decorative, abrasion-resistant, industrial grade self-adhesive tile of FIGS. 6A-6H in accordance with the second preferred embodiment of the present invention.

FIG. 9A is a front perspective view of an alternative embodiment of a cuttable non-decorative, abrasion-resistant, industrial grade self-adhesive tile in accordance with the second preferred embodiment of the present invention.

FIGS. 9B-9D illustrate a method for cutting the cuttable non-decorative, abrasion-resistant, industrial grade self-adhesive tile of FIGS. 9A in accordance with the second preferred embodiment of the present invention.

### DETAILED DESCRIPTION OF THE PREFERRED EMBODIMENTS

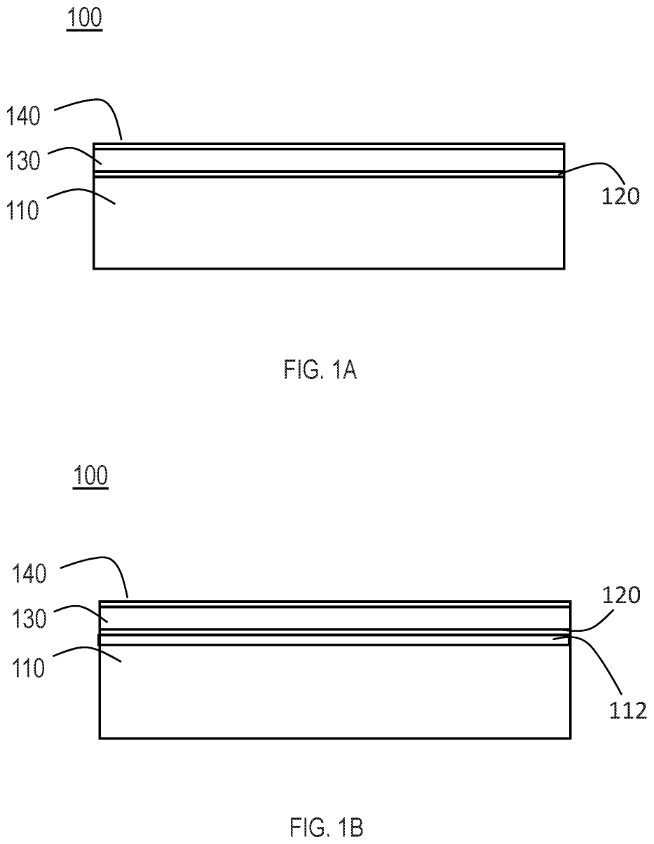

In a preferred embodiment as sown in FIG. 1, the non-decorative industrial grade self-adhesive tile 100 of the present invention has an abrasion-resistant alumina ceramic tile 110 (Component #1), a silane coupling agent 120 (Component #2), and double-sided (double-coated) acrylic foam super high bonding tape 130 with release liner 140 (Component #3). Optionally, as shown in FIG. 1B, a metal backing (Component #4) 112, may be in between Components 1 and 2. In a preferred embodiment, Component #1 is 0.1 mm to 101.6 mm thick, Component #3 is 0.05 mm to 25.4 mm thick, and optional component #4 is 0.1 mm to 25.4 mm thick.

The abrasion-resistant alumina ceramic tile (Component #1), for example, may be comprised of materials selected from the group of aluminum oxide, crystalline silica (amorphous) and magnesium oxide. These ingredients making up the abrasion-resistant alumina ceramic tile preferably are in the following percentage ranges by weight: aluminum oxide (85%-100%), crystalline silica (0.1%-1%) and magnesium oxide (0.1%-1%). Additional ingredients of the ceramic abrasion-resistant tile may include Silica Oxide SiO2 (0.1%-10%), Iron Oxide Fe₂O₃ (0.05%-2%), Titanium Dioxide TiO₂ (0.02%-2%), Calcium Oxide CaO (0.25%-2%), Kalium Oxide K₂O (0.05%-2%) and Sodium Oxide Na₂O (0.1%-2%). In other embodiments, silicon carbide, boron nitride, silicon nitride, tungsten carbide, zirconia, carbon fiber/aluminum composites, aluminum nitride, titanium diboride, yttrium oxide, titanate, or porcelain tile, steel-backed urethane or urethane, for example, may be substituted for the alumina ceramic tile. Still other materials may be used, such as platinum/alloy composites, chromium carbide, AR STEEL 400, AR STEEL 500, AR STEEL 600 and complex carbide composites. Even further, the following materials may be used: Acetal, Canvas Phenolic, Nylon, Polymide, Linen Phenolic, UHMW (Ultra-High-Molecular-Weight POLYETHYLENE), PAI plastic, PBT plastic, PEEK plastic, PET plastic, PPS plastic, PTFE plastic, Manganese Steel, Polycarbonate, Stainless Steel, Iron, Titanium, Zirconium Dioxide, Chrome Steel, Tungsten Carbide, Silicon Nitride, Polypropylene, Cobalt, Urethane, PolyUrethane, Metal-Backed Urethane, Inconel, Maraging Steel, Carbon Steel, Corundum, Copper-Matrix Composites, Titanium Nitride, Zirconium Nitride, Diamond-Like Carbon and optional metal backing on all Tiles/Bricks/Plates.

The silane coupling agent (Component #2) is comprised of materials selected from the group of isopropyl alcohol, water and glycidoxypropyltrimethoxysilane. These ingredients making up the silane coupling agent preferably are in the following percentage ranges by weight: isopropyl alcohol (90%-92%), water (8%-9%) and glycidoxypropyltrimethoxysilane (<1%).

The double-sided (double-coated) acrylic foam super high bonding tape with release liner (Component #3) preferably is made up of a foam carrier, an acrylic adhesive, and a release liner. Preferably the percentage by weight of the foam carrier is 45%-99% and the percentage by weight of the acrylic adhesive is 1%-50%). In other embodiments, the acrylic adhesive may be replaced with polyurethane adhesives, natural rubber adhesives, synthetic rubber adhesives, silicone based adhesive, UV cured adhesive, water activated adhesive, isocyanate adhesives or polytetraflouroethylene adhesive Component #3, however, may be formed of any of the following materials: NON-woven fabric, EPT Ethylene Propylene Terpolymer, PVC Plasticized Polyvinyl Chloride Foam, EVA Ethylene Vinyl Acetate Foam, Vinyl Nitrile Foam, PVC/NBR Vinyl Nitrile Foam, Cling Foam, Ensolite Foams, Nitrile Vinyl Foam, Polyolefin Foam and Silicone Sponge.

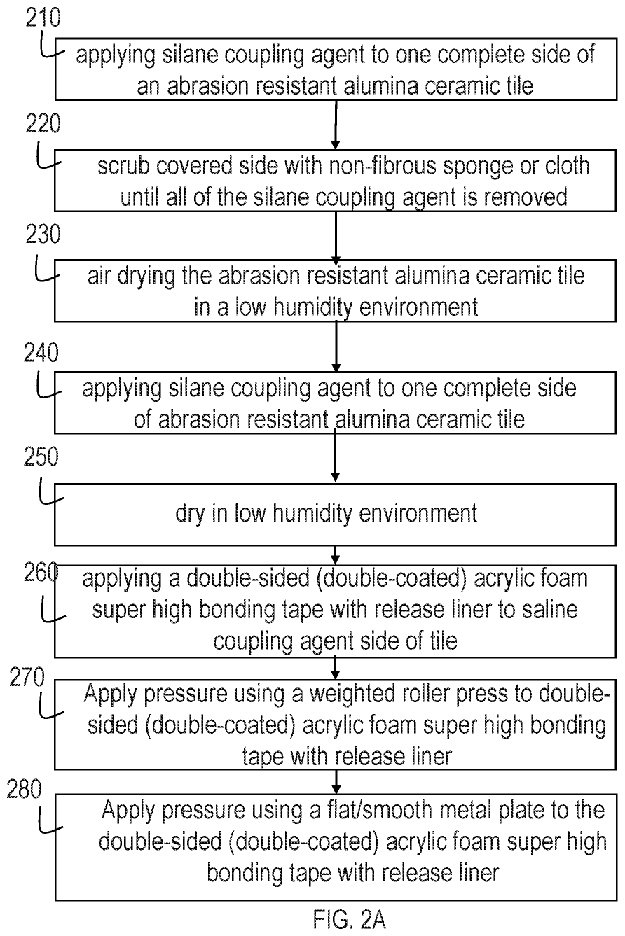

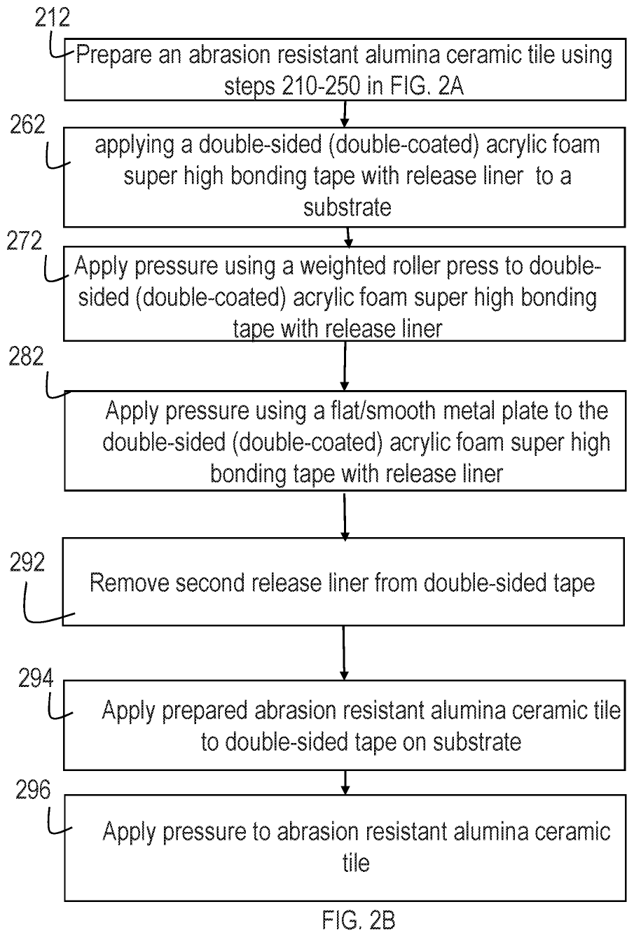

In a preferred embodiment, the non-decorative industrial grade self-adhesive industrial grade tile, brick or plate of the present invention is prepared using the following method, as shown in FIG. 2A.

COMPONENT #1 in its fully manufactured and natural state is inherently hydrophilic. Oxygen atoms in water share some of their electrons with vacant electron orbitals on the aluminum atoms. The oxygen atoms in the ceramic share their electrons with the Hydrogen in the water, resulting in binding the two together.

This (water-loving) state can reduce the initial bonding strength of Component #3 to Component #1 and can compromise the lifespan of the bond, especially in high moisture environments. Therefore Component #2 is applied to Component #1 in a multi-step method. Component #2 is applied to one complete side of Component #1 (210). Moisten a clean, lint-free cloth with the solution and wipe over the entire side of the tile in one direction (220). Let Air Dry in Low Humidity environment (230). Apply a second coating over the entire surface again, this time the coating is thin but adequate to coat the entire surface (240). Do not scrub. Let dry in low humidity environment (250). This will turn the surface of the alumina ceramic tile from hydrophilic to hydrophobic and ensure a very strong initial bond between Component #1 and Component #3 and ensures an extraordinarily strong permanent bond between Component #1 and Component #3. This method also ensures that no water vapor can penetrate the tape bond line.

Component #3 is then applied to the combination of Component #1 and Component #2 (260). The first release liner on the double-sided tape will be removed from one side then Component #3 will be rolled gently onto the “treated” side of Component #1 (270). This will prevent air from being trapped in between Component #3 and the Tile. Using a weighted roller press with pressure exceeding 20 PSI from one edge to another on component #3 stimulating the pressure sensitive adhesive and pushing out any remaining air. Then using a flat/smooth metal plate apply at least 20 PSI of uniform platen pressure to Component #3 (280).

In alternate embodiments, the acrylic foam in Component #3 may be substituted with urethane foam, polyester urethane (PU Ester), polyether urethane (PU Ether), microcellular cross-linked polyethylene foam, microcellular urethane foam, microcellular polyurethane foam, open cell sponge, sponge rubber, felt, melamine foam, polyimide foam, silicone foam, PVC foam, neoprene sponge blend, cross-linked PE foam, EPDM foam blend, cork, EVA foam, nitrile sponge blend natural rubber, SBR, butyl rubber, santoprene, EPDM rubber, silicone rubber, neoprene rubber, of buna nitrile.

In a further alternate embodiment, the present invention has only Component #1 and Component #3. In other embodiments, the present invention may have military applications rather than industrial applications.

The tiles 100 can be applied to a substrate (e.g., a wall of a grain elevator) by removing the second release liner 140 of the double-sided tape and then pressing the tile onto the substrate.

FIG. 2B illustrates and alternate method in which the tile is installed directly onto the substrate without being fully assembled in advance of installation. The abrasion-resistant alumina ceramic tile may be prepared as shown in FIG. 2A steps 210-250 (121). The tile is then installed by removing a first release liner from a double-sided double-coated acrylic foam super high bonding tape to a substrate and then applying the double-sided tape to the substrate (262). Pressure is then applied to the double sided tape using a weighted roller (272). Pressure is then applied using a flat/smooth metal plate to the double-sided (double-coated) acrylic foam super high bonding tape (282). The second release liner is then removed from the double-sided tape (292). Abrasion-resistant alumina ceramic tile is applied onto the exposed side of the double-sided tape (294). Finally, pressure is applied to the tile (296).

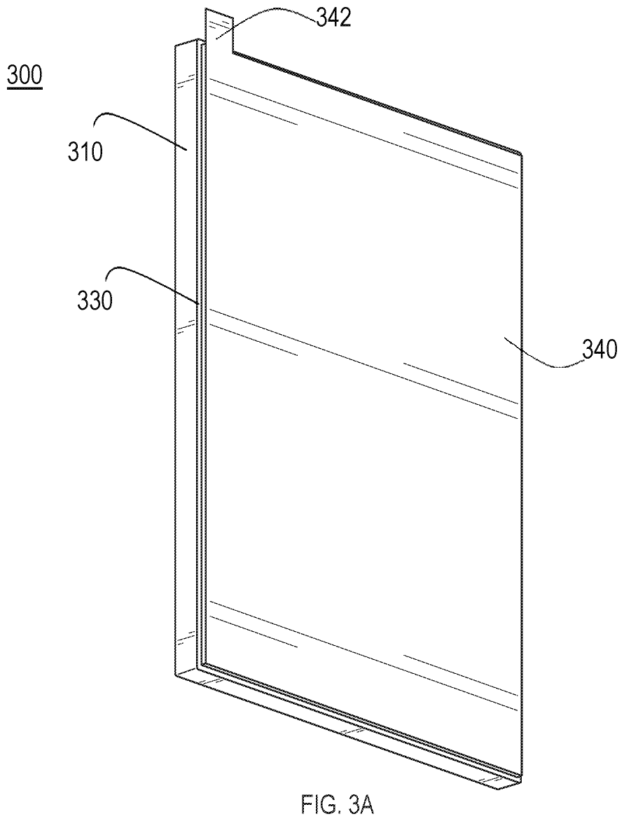

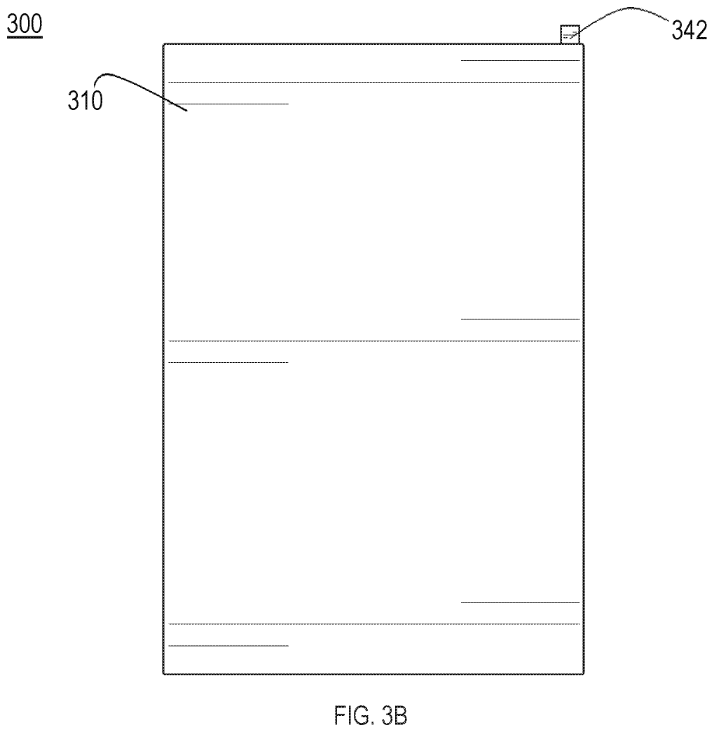

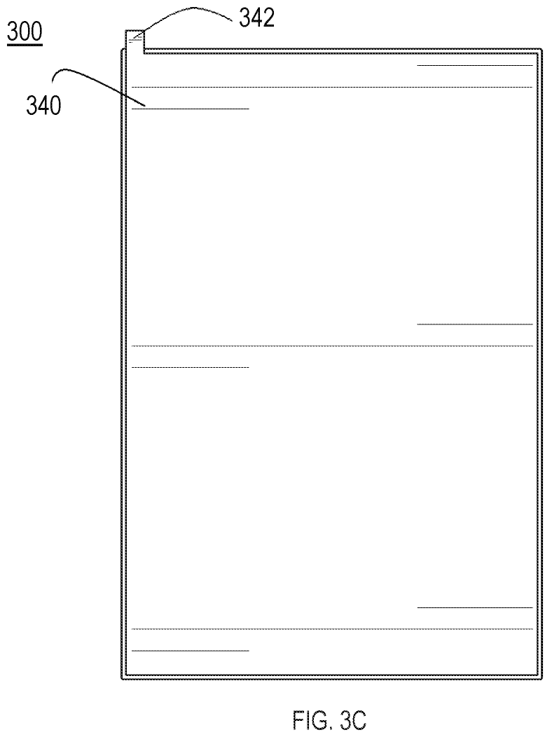

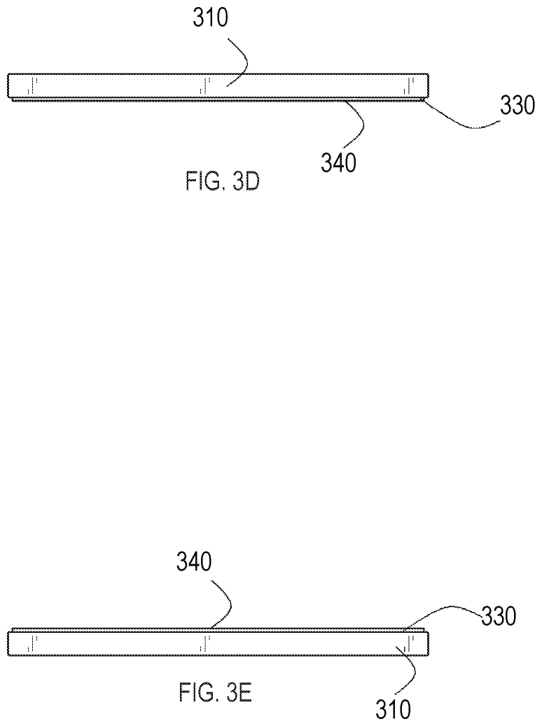

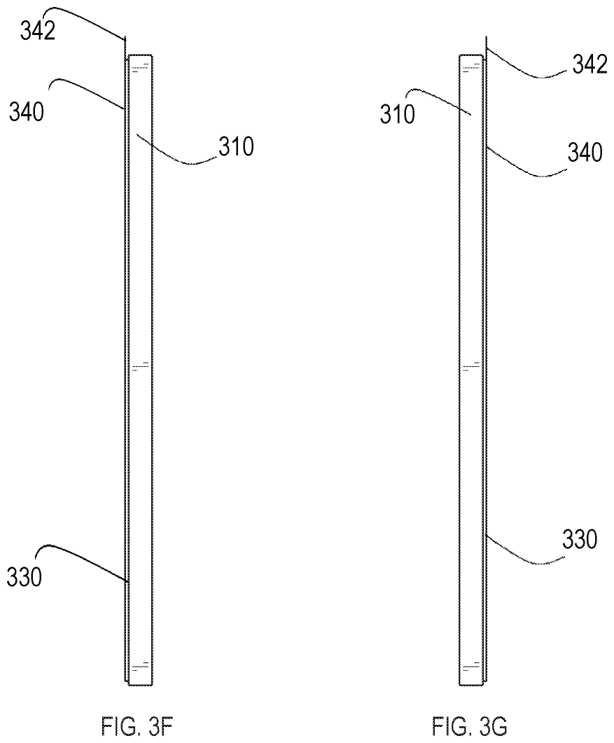

FIGS. 3A-3G illustrate an embodiment of a 4″×6″ non-decorative industrial grade self-adhesive tile in accordance with the present invention. The tile, brick or plate, of course, may be made with other dimensions.

The non-decorative industrial grade self-adhesive tile 300 of the present invention has an abrasion-resistant alumina ceramic tile 310, a silane coupling agent 320, and double-sided (double-coated) acrylic foam super high bonding tape with release liner 330.

In a preferred embodiment as sown in FIG. 1, the non-decorative industrial grade self-adhesive tile 100 of the present invention has an abrasion-resistant alumina ceramic tile 110 (Component #1), a silane coupling agent 120 (Component #2), and double-sided (double-coated) acrylic foam super high bonding tape 130 with release liner 140 (Component #3). Optionally, as shown in FIG. 1B, a metal backing (Component #4) 112, may be in between Components 1 and 2. In a preferred embodiment, Component #1 is 0.1 mm to 101.6 mm thick, Component #3 is 0.05 mm to 25.4 mm, and optional component #4 is 0.1 mm to 25.4 mm thick.

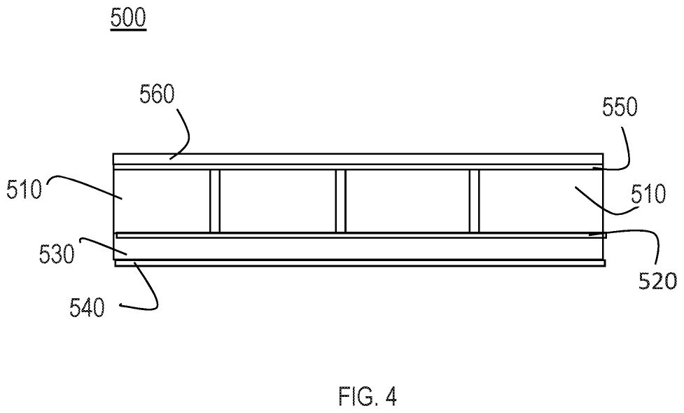

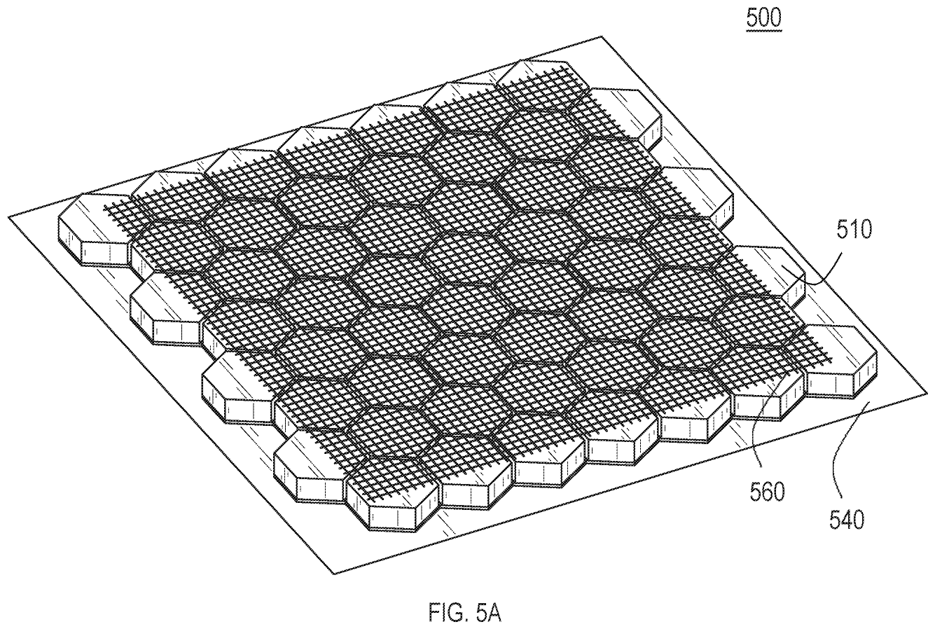

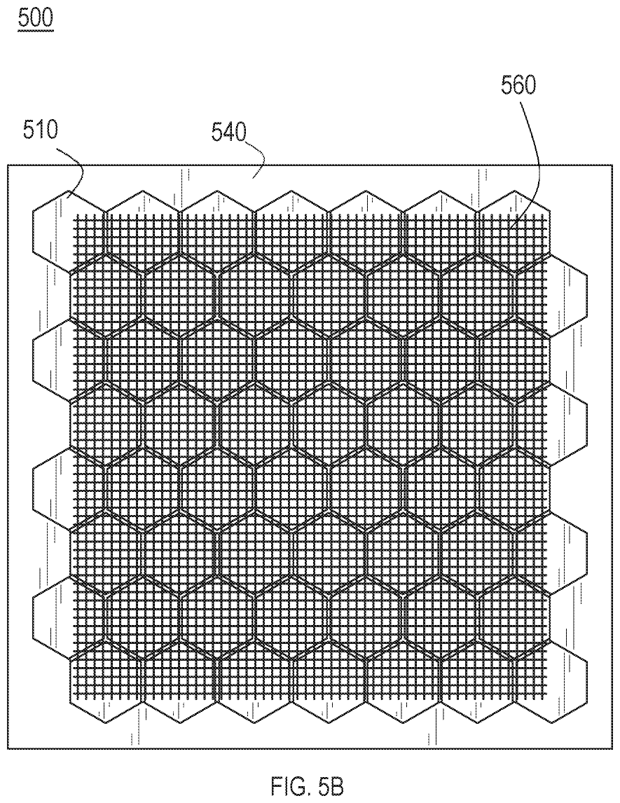

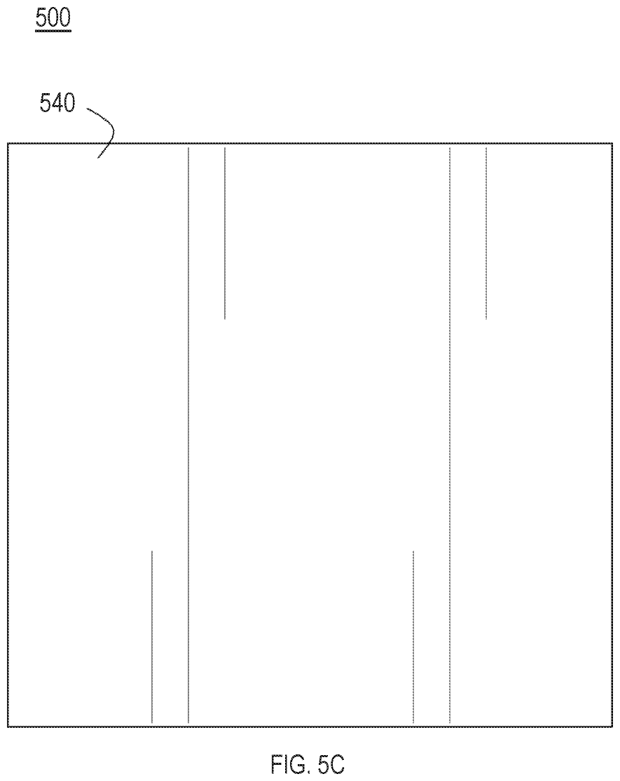

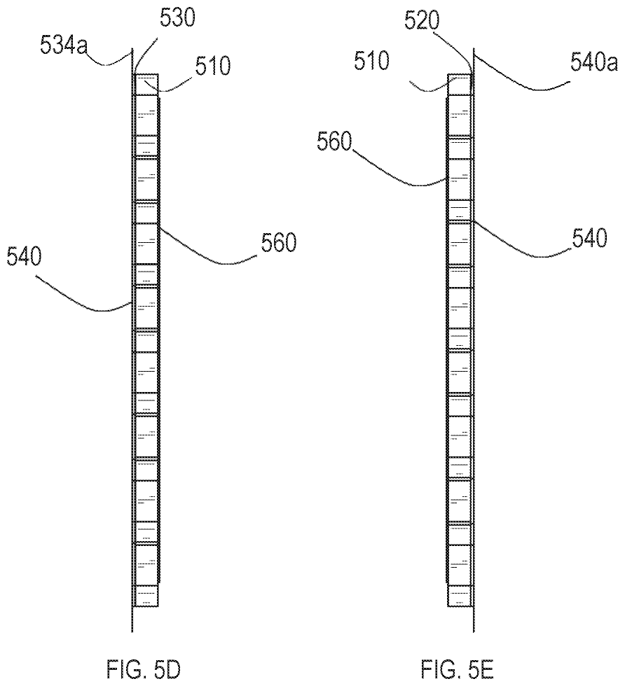

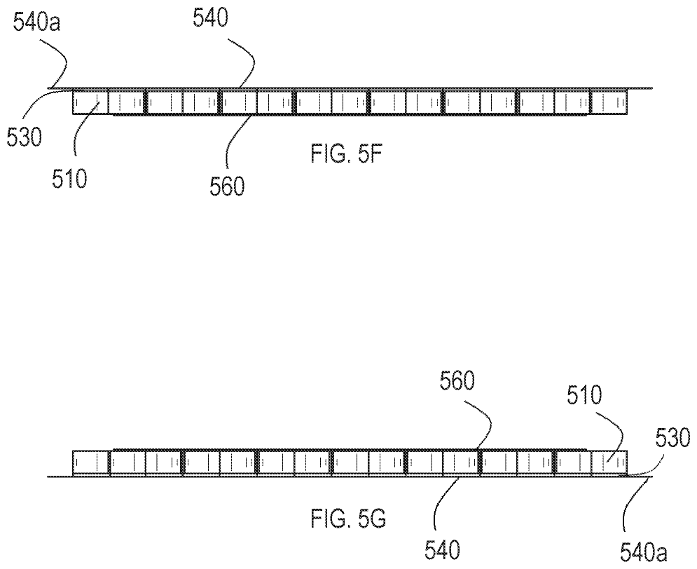

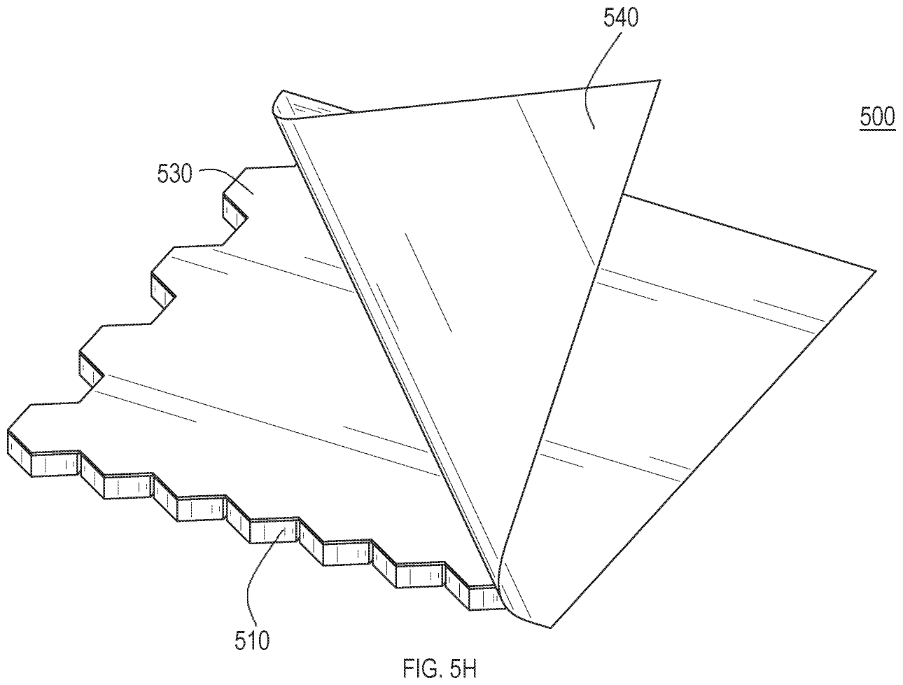

In an alternate preferred embodiment as shown in FIGS. 4 and 5A-H, the non-decorative industrial grade self-adhesive tile 500 of the present invention has a plurality of abrasion-resistant alumina ceramic tiles 510 (Component #1), a silane coupling agent 520 (Component #2), and double-sided (double-coated) acrylic foam super high bonding tape 530 with release liner 540 (Component #3). An adhesive 450 secures a flexible mesh 460 to an opposite side of the plurality of tiles 510. This design allows for flexibility of the tile 400 to provide better adhesive to contoured substrate surfaces. As with the embodiment of FIG. 1A, the tiles 510 may be of many different types of materials. Also, the tile 400 similarly is installed by removing release liner 440 and pressing the tile onto the substrate surface.

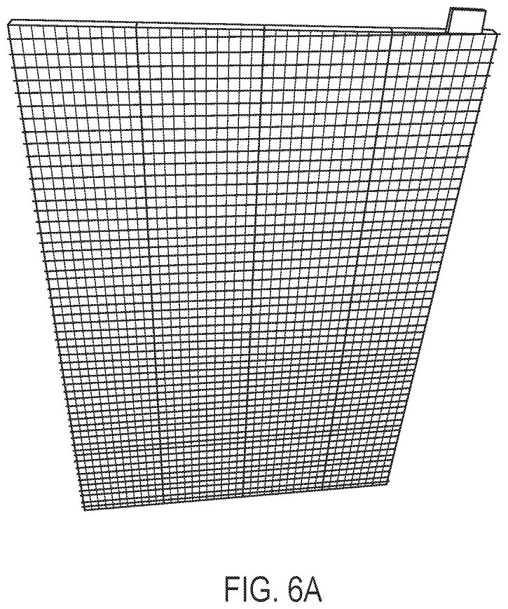

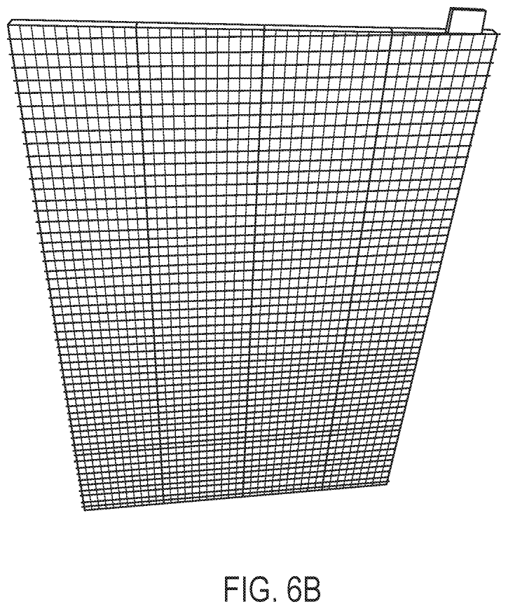

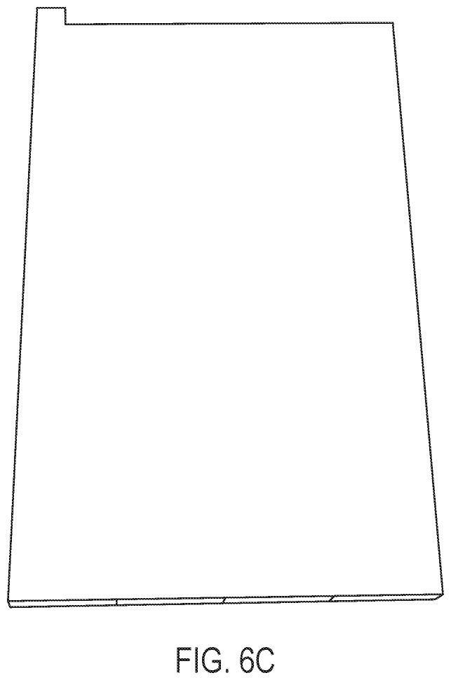

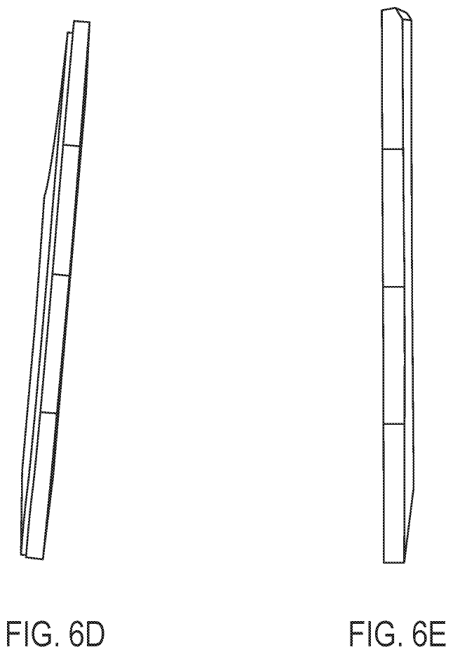

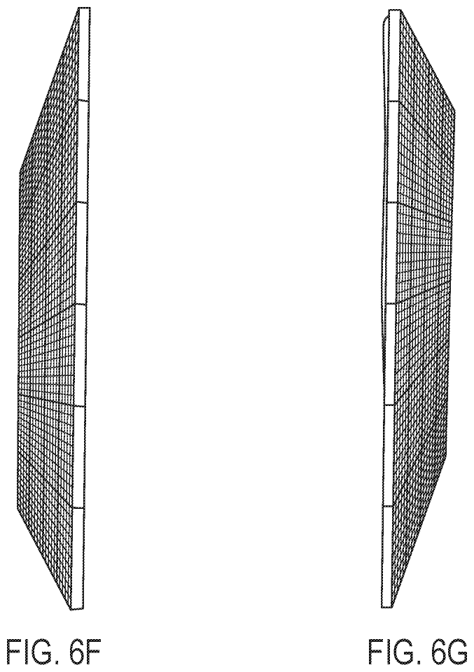

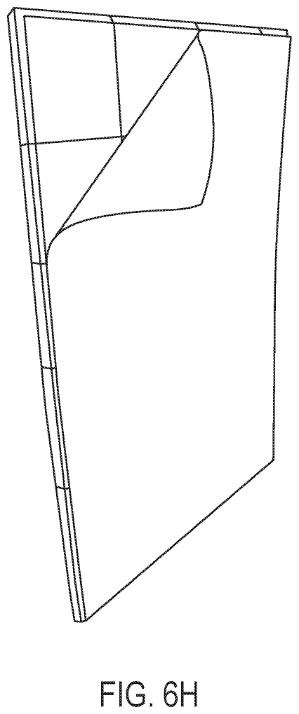

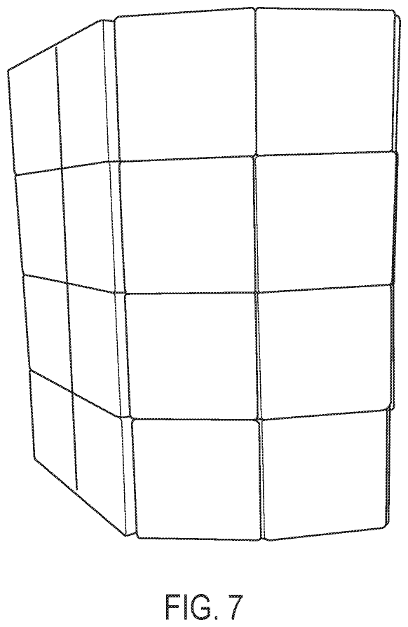

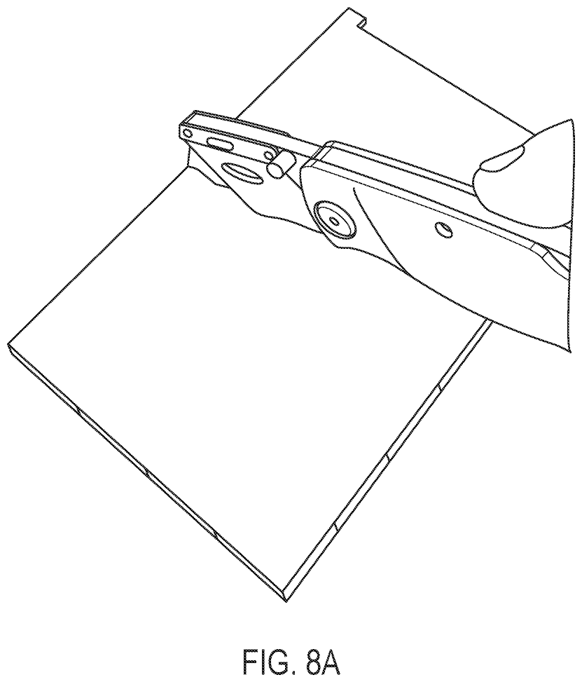

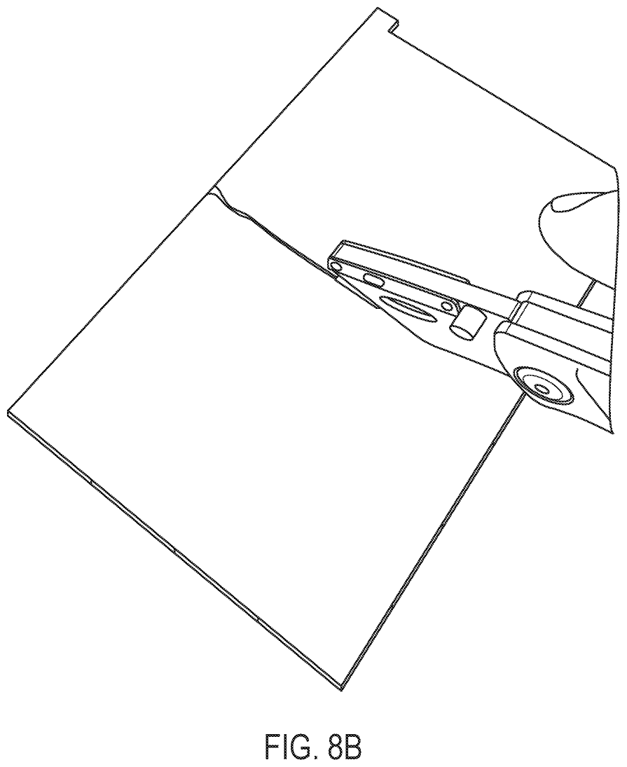

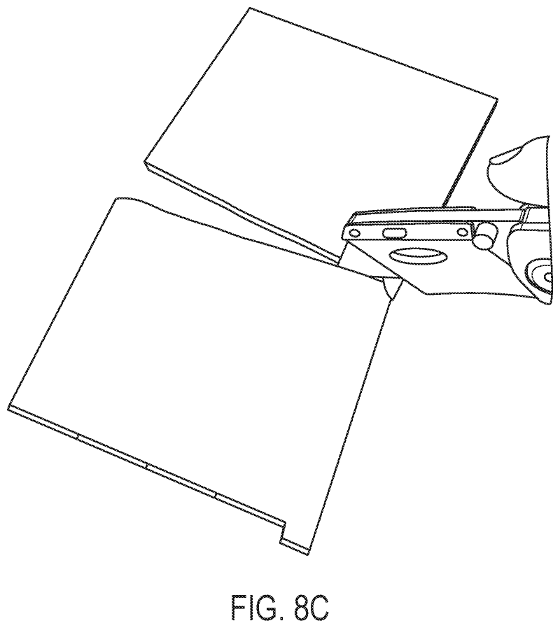

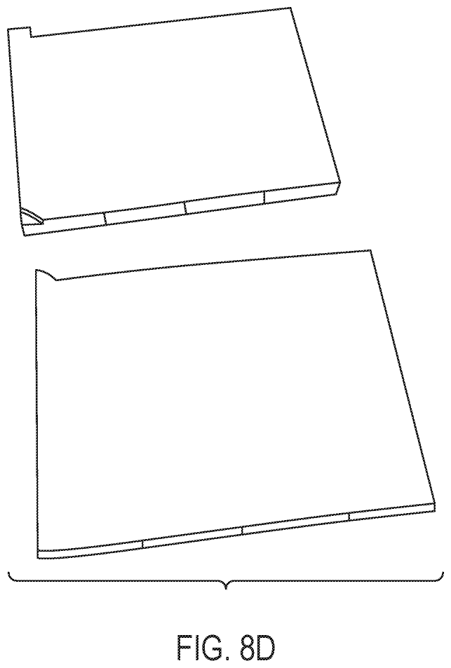

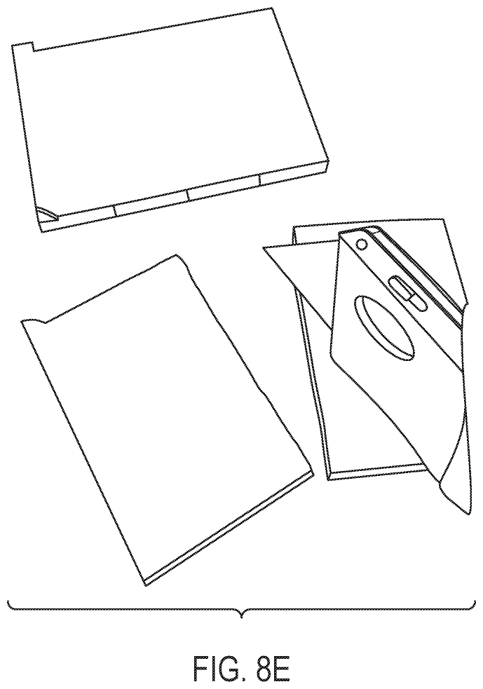

FIGS. 6A-6H illustrate an embodiment of the present invention in which the self-adhesive, non-decorative, abrasion-resistant industrial grade tile can be cut (i.e., is “cuttable”) into smaller sizes. This embodiment is very similar to the industrial hex tile embodiment described above, except the individual tile pieces that make up the industrial grade tile are square rather than hexagonal. The manufacturing process is effectively the same as with the hex tile embodiment except the individual tile pieces are placed closer adjacent to one another rather than being spaced like the industrial hex tile pieces. As shown in FIG. 7, this creates an industrial grade tile that flexes along the vertical and horizontal lines between the rows and columns of individual tile pieces. As shown in FIGS. 8A-8E, this allows the industrial grade tiles to be easily cut along the line between the tile pieces into various shapes and sizes.

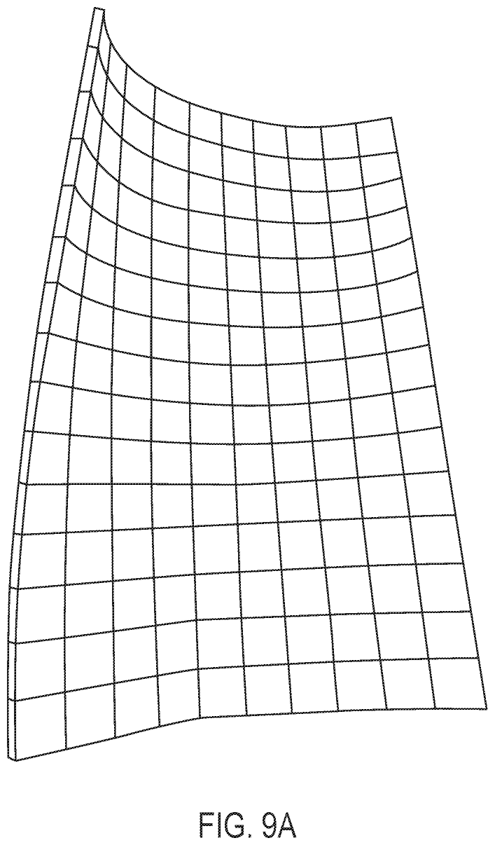

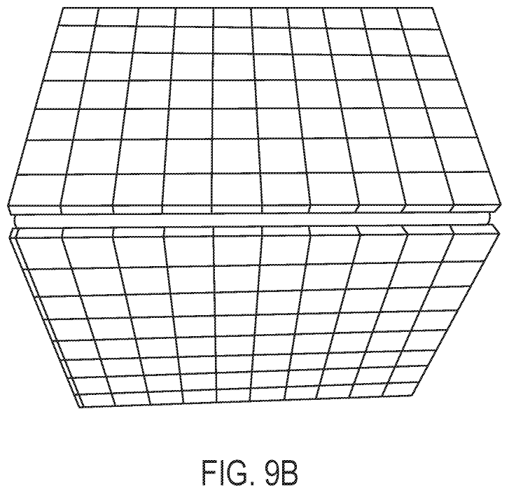

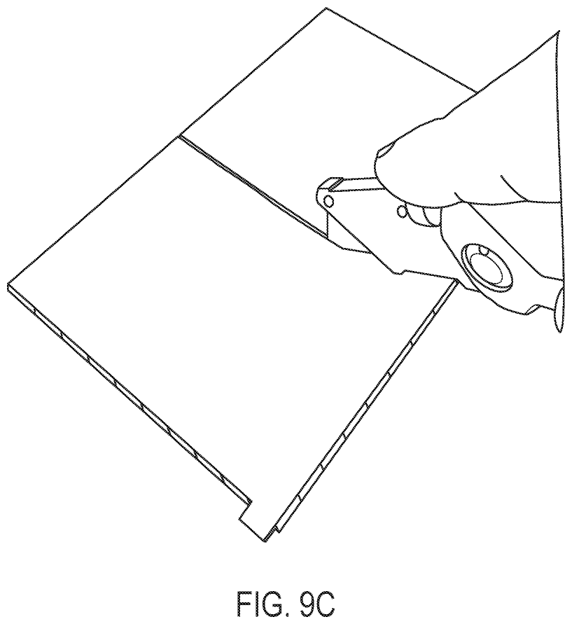

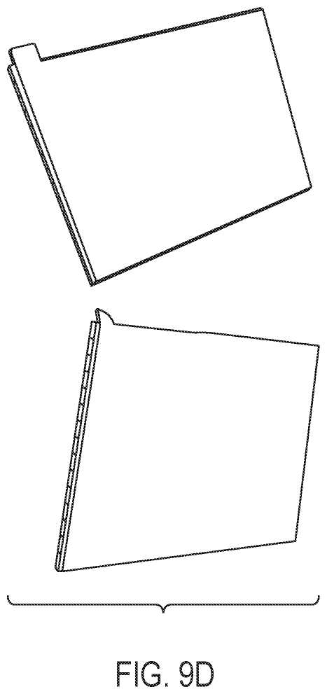

Another alternative cuttable embodiment is shown in FIGS. 9A-9G. In this embodiment, instead of a mesh initially holding the individual tile pieces together as described above a clear flexible tape is used. In still other embodiments, a material such as Acetic Cloth can be used rather than mesh or tape.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

1. A non-decorative industrial grade self-adhesive tile comprising:
an abrasion-resistant tile;
a silane coupling agent; and
double-sided (double-coated) acrylic foam super high bonding tape with release liner,
wherein the abrasion-resistant tile is comprised of materials selected from the group of aluminium oxide, crystalline silica and magnesium oxide; and
wherein aluminum oxide forms 85%-100% by weight of the abrasion-resistant alumina ceramic tile.

2. A non-decorative industrial grade self-adhesive tile comprising:
an abrasion-resistant tile;
a silane coupling agent; and
double-sided (double-coated) acrylic foam super high bonding tape with release liner;
wherein the abrasion-resistant tile is comprised of materials selected from the group of aluminum oxide, crystalline silica and magnesium oxide; and
wherein crystalline silica forms 0.1%-1% by weight of the abrasion-resistant alumina ceramic tile.

3. (canceled)

4. A non-decorative industrial grade self-adhesive tile according to claim 1, wherein crystalline silica forms 0.1%-1% by weight of the abrasion-resistant alumina ceramic tile.

5. A non-decorative industrial grade self-adhesive tile according to claim 1, wherein magnesium oxide forms 0.1%-1% by weight of the abrasion-resistant alumina ceramic tile.

6. A non-decorative industrial grade self-adhesive tile according to claim 1 wherein the silane coupling agent is comprised of materials selected from the group of isopropyl alcohol, water and glycidoxypropyltrimethoxysilane.

7. A non-decorative industrial grade self-adhesive tile according to claim 6 wherein isopropyl alcohol forms 90%-92% by weight of the silane coupling agent.

8. A non-decorative industrial grade self-adhesive tile according to claim 6, wherein water forms 8%-9% by weight of the silane coupling agent.

9. A non-decorative industrial grade self-adhesive tile according to claim 6 wherein glycidoxypropyltrimethoxysilane forms greater than 0% but less than 1% by weight of the silane coupling agent.

10. A non-decorative industrial grade self-adhesive tile according to claim 6 wherein the double-sided (double-coated) acrylic foam super high bonding tape comprises a foam carrier and an acrylic adhesive.

11. A method for manufacturing a non-decorative industrial grade self-adhesive tile comprising:
applying a silane coupling agent to one complete side of an abrasion-resistant alumina ceramic tile;
gently scrubbing the covered side of abrasion-resistant alumina ceramic tile with a non-fibrous sponge or cloth until all of the silane coupling agent is removed;
air drying the abrasion-resistant alumina ceramic tile in a low humidity environment;
applying a silane coupling agent to one complete side of the abrasion-resistant alumina ceramic tile a second time;
let the abrasion-resistant alumina ceramic tile dry in low humidity environment;
applying a double-sided (double-coated) acrylic foam super high bonding tape with release liner to the combination of abrasion-resistant alumina ceramic tile and silane coupling agent by removing a release liner from one side of the double-sided (double-coated) acrylic foam super high bonding tape with release liner and then rolling the double-sided (double-coated) acrylic foam super high bonding tape with release liner onto the Silane coupling agent on the abrasion-resistant alumina ceramic tile;
using a weighted roller press with pressure exceeding 20 PSI from one edge to another on double-sided (double-coated) acrylic foam super high bonding tape with release liner stimulating a pressure sensitive adhesive and pushing out any remaining air;
using a flat/smooth metal plate apply at least 20 PSI of uniform platen pressure to the double-sided (double-coated) acrylic foam super high bonding tape with release liner.

12. The method for manufacturing a non-decorative industrial grade self-adhesive tile according to claim 11, wherein the abrasion-resistant tile is comprised of materials selected from the group of aluminum oxide, crystalline silica and magnesium oxide.

13. The method for manufacturing a non-decorative industrial grade self-adhesive tile according to claim 12, wherein crystalline silica forms 0.1%-1% by weight of the abrasion-resistant alumina ceramic tile.

14. The method for manufacturing a non-decorative industrial grade self-adhesive tile according to claim 12, wherein the silane coupling agent is comprised of materials selected from the group of isopropyl alcohol, water and glycidoxypropyltrimethoxysilane.

15. The method for manufacturing a non-decorative industrial grade self-adhesive tile according to claim 14, wherein glycidoxypropyltrimethoxysilane forms greater than 0% but less than 1% by weight of the silane coupling agent.

16. A non-decorative industrial grade self-adhesive tile according to claim 2 wherein magnesium oxide forms 0.1%-1% by weight of the abrasion-resistant alumina ceramic tile.

17 A non-decorative industrial grade self-adhesive tile according to claim 2 wherein the silane coupling agent is comprised of materials selected from the group of isopropyl alcohol, water and glycidoxypropyltrimethoxysilane.
